(19) United States
(12) Patent Application Publication
(10) Pub. No.: US 2007/0179786 A1
(43) Pub. Date: Aug. 2, 2007

(54) Av content processing device, av content processing method, av content processing program, and integrated circuit used in av content processing device

(76) Inventors: Meiko Masaki, Nara (JP); Takashi Kawamura, Osaka (JP); Masayuki Misaki, Hyogo (JP); Toshihiko Date, Nara (JP); Taro Katayama, Kanagawa (JP); Haruyo Ohkubo, Osaka (JP); Kazuhiro Kuroyama, Osaka (JP)

Correspondence Address: WENDEROTH, LIND & PONACK L.L.P., 2033 K. STREET, NW, SUITE 800, WASHINGTON, DC, 20006, US

(21) Appl. No.: 10/589,491

(22) PCT Filed: Jun. 15, 2005
(86) PCT No.: PCT/JP05/10956

§ 371 Date: Aug. 15, 2006

(30) Foreign Application Priority Data
Jun. 18, 2004 (JP) 2004-181021

(51) Int. Cl. G10L 21/00

(52) U.S. Cl. 704/270

(57) ABSTRACT

There is provided an AV content processing device operable to reduce unpleasantness caused to a user when a detection error occurs in detecting a CM section.

A CM detection unit (101) detects a CM section based on a power level of a sound signal in a stored AV content or the like, and acquires information indicating boundaries between the CM section and program sections. The user inputs, via a purpose reception unit (102), a view purpose to view the AV content. Boundary A boundary correction unit (103) shifts, in accordance with the view purpose inputted by the user, positions of the boundaries (a start point and an end point) between the CM section detected by the CM detection unit (101) and the program sections such that the detected CM section becomes long or short.

### TECHNICAL FIELD

The present invention relates to a device for performing a reproduction of an AV content or the like, and more specifically, to a detection of a CM section.

### BACKGROUND ART

Conventionally, a switching time interval detection method is known as a method for distinguishing between a portion corresponding to a commercial message (hereinafter, referred to as a “CM”) and a portion corresponding to a program content in a television broadcast signal (see patent document 1, for example). In this method, by focusing on characteristics of an AV signal such as a change in a sound signal level, a change in an image signal, and multiplexing of a sound signal, an identification device for identifying a CM portion detects a portion where a CM and a program are switched. Then, the identification device determines whether or not the detected portion where the switching occurred has a predetermined time interval, and thereby identifying a CM portion in a content to be recorded/reproduced by a recording/reproduction device. With this scheme, it is possible to detect a commercial message without recognizing whether a broadcast is in stereo or monaural.

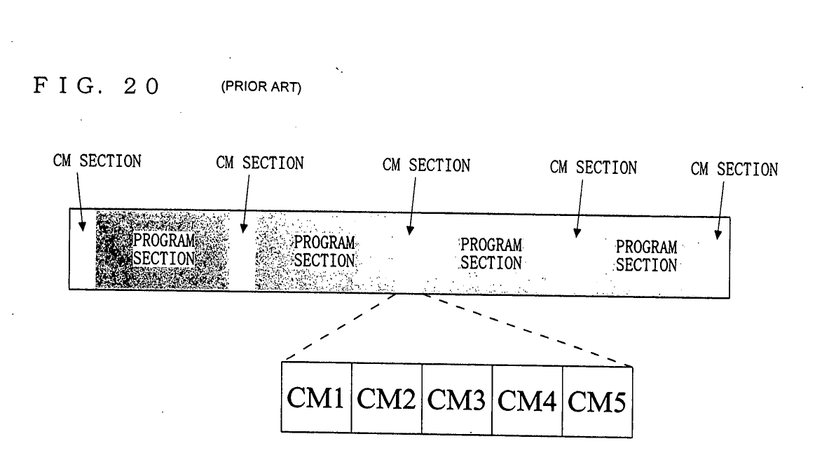

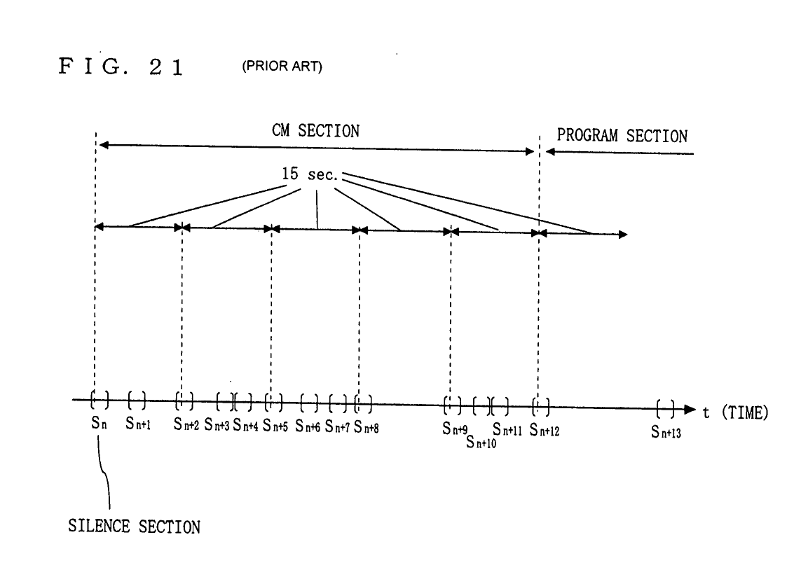

With reference to FIGS. 20 and 21, an example of a conventional method for detecting a CM section is described. FIG. 20 is a diagram schematically showing program sections and CM sections in a broadcast content. In FIG. 20, the broadcast content includes program sections and CM sections. Also, the CM sections include one or more (five, in FIG. 20) CM clips (hereinafter, referred to as “CMs”). A CM generally has the following characteristics. In the beginning and in the end of the CM, a silence section is included, and one CM has a specified time period (generally, it is one of fifteen, thirty, sixty seconds) Using these characteristics, a change in a sound signal level is detected, whereby it becomes possible to detect a CM section.

Next, with reference to FIG. 21, an example of a method for detecting a CM section is described. Here, it is assumed that the length of one CM is fifteen seconds. Firstly, the identification device detects a change in the sound signal level so as to extract a silence section Sn+m (m=0,1, 2, 3, . . . ) in the broadcast content. Next, using the characteristic that a CM has a silence section in the beginning and in the end thereof, the identification device detects a section where silence sections Sn are found with intervals of fifteen seconds therebetween. In FIG. 21, the identification device firstly detects a time interval between a silence section Sn and a silence section Sn+1, and determines whether or not the time interval is equal to or shorter than fifteen seconds. If it is shorter than fifteen seconds, the identification device detects a time interval between the silence section Sn and a silence section Sn+2, for which one is added to m. In other words, the identification device sequentially detects a time interval between the silence section Sn and the silence section Sn+1, the silence section Sn and the Sn+2, and so on. If the time interval is fifteen seconds between the silence section Sn and a silence section Sn+i (i is an integer equal to or greater than one), it is determined that a section between the silence section Sn and the silence section Sn+i is a section corresponding to a CM (unit CM section). On the other hand, if the time interval between the silence section Sn and the silence section Sn+i is longer than fifteen seconds, a section between the silence section Sn and the silence section Sn+i is determined as a program section. In a case of FIG. 20, the time interval between the silence section Sn and the silence section Sn+2 is fifteen seconds. Therefore, the identification device detects a section between the silence section Sn and the silence section Sn+2 as a unit CM section. When a unit CM section is detected, the identification device uses the silence section Sn+2 corresponding to an end of the unit CM section as a reference for determining whether or not a time interval between the silence section Sn+2 and a next silence section is equal to or shorter than fifteen seconds. If the time interval is fifteen seconds between the silence section Sn+2 and a silence section Sn+j (j=3, 4, 5, . . . ), the identification device determines that a section between the silence section Sn and the silence section Sn+j corresponds to a unit CM section.

Accordingly, the identification device detects a section where a time interval between a silence section and another silence section is fifteen seconds as a unit CM section. Then, a section successively including equal to or greater than a predetermined number (e.g., equal to or greater than three) of unit CM sections is detected as a CM section. In FIG. 21, each of five sections, i.e., a section between the silence section Sn and the silence section Sn+2, a section between the silence section Sn+2 and a silence section Sn+5, a section between the silence section Sn+5 and a silence section Sn+8, a section between the silence section Sn+8 and a silence section Sn+9, and a section between the silence section Sn+9 and a silence section Sn+12, is detected as a unit CM section. Because these five unit CM sections are successive, a section for which these five unit CM sections are combined is detected as a CM section. Note that, here, although fifteen seconds is used for determination, there may be a case where a CM is detected based on whether or not it is thirty seconds or sixty seconds, in addition to using fifteen seconds.
[patent document 1] Japanese laid-Open Patent Publication No. 2-81344

### DISCLOSURE OF THE INVENTION

### Problems to be Solved by the Invention

With the above-described method for detecting a CM section, however, a detection error occurs because there may be a case where a program has characteristics same as the aforementioned characteristics of a CM, or, conversely, a CM does not have such aforementioned characteristics. Generally, a silence section is included in the beginning and in the end of a CM, and, during the silence section, a power level of a sound signal is lowered. However, in some CMs, power levels are not lowered. For such a section where a change in a power level is insufficient, the section cannot be detected as a CM section with the above-described detection scheme. In other words, even if a section is actually a CM section, the section is not detected as a CM section if a change in a power level or the like of a sound signal thereof is insufficient. Also, when two silence sections having a predetermined time interval therebetween are detected, a section between the two silence sections is detected as a unit CM section, even when the section is actually a program section. As such, with the conventional detection method, an accurate detection for all CM sections is difficult.

For example, consider a case where a section which is actually a program section is determined as a CM section because of the above-described detection error in detecting a CM section. In such a case, when a CM skip reproduction is performed, the section determined as a CM section is skipped despite being actually a program section. When a program section is determined as a CM section due to an erroneous detection, a user fails to view a portion of the program section, and thereby presumably causing unpleasantness. In other words, in a case where the conventional detection method is used as it is, when a detection error occurs as described above, the user may become displeased because of the error in detection.

Therefore, an object of the present invention is to provide an AV content processing device operable to reduce unpleasantness caused to a user when a detection error occurs in detecting a CM section.

### SOLUTION TO THE PROBLEMS

To achieve the above object, the present invention has the following aspects.

A first aspect of the present invention is directed to an AV content processing device for outputting at least a portion of an AV content including a program section and a CM section, and the AV content processing device includes: an acquisition unit for acquiring boundary information indicative of a boundary between the program section and the CM section; a first reception unit for receiving from a user an instruction for extracting and outputting a predetermined section in the AV content; a boundary correction unit for selecting, in accordance with the instruction received by the first reception unit, whether the boundary is shifted in a direction for the CM section to be long or short, and correcting a content of the boundary information such that the boundary is shifted in accordance with the selected direction; and an output control unit for determining, when the instruction is received by the first reception unit, the boundary between the program section and the CM section in accordance with the corrected boundary information, and extracting and outputting a section indicated by the instruction. Note that, besides outputting an AV content to a monitor or the like, the outputting described above includes outputting an AV content to a separate storage medium.

In a second aspect of the present invention based on the first aspect, the first reception unit is operable to receive from the user a program output instruction for outputting at least a portion of the program section of the AV content and a CM output instruction for outputting at least a portion of the CM section of the AV content, the boundary correction unit corrects the content of the boundary information such that the boundary is shifted in the direction for the CM section to be short when the program output instruction is received by the first reception unit, and corrects the content of the boundary information such that the boundary is shifted in the direction for the CM section to be long when the CM output instruction is received by the first reception unit, and the output control unit extracts and outputs, when the program output instruction is received by the first reception unit, a section indicated as a program section according to the corrected boundary information, and extracts and outputs, when the CM output section is received by the first reception unit, a section indicated as a CM section according to the corrected boundary information.

In a third aspect of the present invention based on the second aspect, a second reception unit for receiving from the user a skip instruction for skipping a portion of the AV content being outputted by the output control unit is further included, and, when the skip instruction is received by the second reception unit during an output of the AV content between a boundary indicating a start point of a CM section according to the boundary information not having been corrected and a boundary indicating a start point of the CM section according to the boundary information having been corrected, the output control unit causes the output of the AV content to be skipped to an endpoints of the CM section according to the boundary information having been corrected, and, when the skip instruction is received by the second reception unit during an output of the AV content between a boundary indicating an end point of the CM section according to the boundary information not having been corrected and a boundary indicating the end point of the CM section according to the boundary information having been corrected, causes the output of the AV content to be skipped to the endpoints of the CM section according to the boundary information not having been corrected.

In a fourth aspect of the present invention based on the first aspect, a detection unit for calculating a parameter indicating characteristics of one of a sound and an image in the AV content and detecting a section for which the parameter satisfies a predetermined condition as a characteristic section is further included, the reception unit is operable to receive from the user a characteristics output instruction for extracting and outputting the characteristic section in the program section, the boundary correction unit corrects, when the characteristics output instruction is received by the first reception unit, a content of the boundary information such that the boundary is shifted in the direction for the CM section to be long, and the output control unit extracts and outputs, when the characteristics output instruction is received by the first reception unit, the characteristic section included in a section indicated as a program section according to the corrected boundary information.

In a fifth aspect of the present invention based on the first aspect, a detection unit for calculating a parameter indicating characteristics of one of a sound and an image in the AV content and detecting a section for which the parameter satisfies a predetermined condition as a characteristic section is further included, the reception unit is operable to receive from the user a characteristics output instruction for extracting and outputting the characteristic section in the program section, the boundary correction unit corrects, when the characteristics output instruction is received by the first reception unit, a content of the boundary information such that the boundary is shifted in a direction for the CM section to be short, and the output control unit extracts and outputs, when the characteristics output instruction is received by the first reception unit, the characteristic section included in a section indicated as a program section according to the corrected boundary information.

In a sixth aspect of the present invention based on the first aspect, the acquisition unit further acquires CM number information indicating the number of CMs in the CM section and length information indicating a length of the CM section, and the boundary correction unit selects an amount of shift performed for a boundary indicating a start point and boundary indicating an end point of the CM section, based on the CM number information and length information for the CM section.

In a seventh aspect of the present invention based on the first aspect, the boundary correction unit selects an amount of shift performed for a boundary indicating a start point and boundary indicating an end point of the CM section, based on a length of a program section immediately before the CM section.

In an eighth aspect of the present invention based on the first aspect, the boundary correction unit selects an amount of shift performed for a boundary indicating a start point and boundary indicating an end point of the CM section, based on a ratio of a length from a start of the AV content to the CM section to a length of the entire AV content.

In a ninth aspect of the present invention based on the first aspect, the boundary correction unit corrects, when a predetermined condition is satisfied for the CM section, the boundary information such that a boundary indicating a start point and boundary indicating an end point of the CM section are erased.

In a tenth aspect of the present invention based on the first aspect, a program information acquisition unit for acquiring program information which is information concerning a program included in the AV content is further included, and the boundary correction unit changes an amount of shift performed for the boundary based on the acquired program information.

An eleventh aspect of the present invention is directed to an AV content processing method for outputting at least a portion of an AV content including a program section and a CM section, and the AV content processing method includes: an acquisition step of acquiring boundary information indicating a boundary between the program section and the CM section; a first reception step of receiving from a user an instruction for extracting and outputting a predetermined section in the AV content; a boundary correction step of selecting, in accordance with a type of the instruction received by the first reception step, whether the boundary is shifted in a direction for the CM section to be short or long, and correcting a content of the boundary information such that the boundary is shifted in the selected direction; and an output control step of determining, when the instruction is received by the first reception step, the boundary between the program section and the CM section in accordance with the corrected boundary information, and extracting and outputting a section indicated by the instruction.

A twelfth aspect of the present invention is directed to an AV content processing program executed by a computer of an AV content processing device for outputting at least a portion of an AV content including a program section and a CM section, and the AV content processing device causes the computer to execute: an acquisition step of acquiring boundary information indicative of a boundary between the program section and the CM section; a first reception step of receiving from a user an instruction for extracting and outputting a predetermined section in the AV content; a boundary correction step of selecting, in accordance with a type of the instruction received by the first reception step, whether the boundary is shifted in a direction for the CM section to be short or long, and correcting a content of the boundary information such that the boundary is shifted in the selected direction; and an output control step of determining, when the instruction is received by the first reception step, the boundary between the program section and the CM section in accordance with the corrected boundary information, and extracting and outputting a section indicated by the instruction.

A thirteenth aspect of the present invention is directed to an integrated circuit used in an AV content processing device for outputting at least a portion of an AV content including a program section and a CM section, and the integrated circuit includes: an acquisition section for acquiring boundary information indicative of a boundary between the program section and the CM section; and a boundary correction section for a user to input an instruction for extracting and outputting a predetermined section in the AV content, for selecting, in accordance with a type of the instruction, whether the boundary is shifted in a direction for the CM section to be short or long, and correcting a content of the boundary information such that the boundary is shifted in the selected direction.

### EFFECT OF THE INVENTION

According to the first aspect of the present invention, a position of a boundary between a program section and a CM section can be corrected. Therefore, in a CM skip reproduction or the like, it is possible to prevent a portion of the program from being failed to be viewed, the miss being due to an erroneous detection of a CM. Accordingly, it is possible to reduce unpleasantness caused, to the user, by reproducing an erroneously detected CM section, and therefore to provide a pleasant environment for viewing an AV content.

According to the second aspect of the present invention, a CM section is reduced when a program output instruction is received, and the CM section is increased when a CM output instruction is received. Accordingly, in the program output instruction, a section detected as a CM section despite being a program section can be outputted as a program section, whereby it is possible to reduce the amount of program sections being failed to be viewed. Also, in the CM output instruction, a section detected as a program section despite being a CM section can be outputted as a CM section, whereby it is possible to reduce the amount of CM sections being failed to be viewed.

According to the third aspect of the present invention, when a CM is reproduced even when a CM section having been corrected is used, with a skip instruction from a user, the reproduction can be skipped to an end point of the CM section having been corrected or a CM section not corrected. Accordingly, a program section is prevented from being failed to be viewed, the reproduction of CMs can be skipped, and the user can be provided with an AV content to be viewed with pleasantness.

According to the fourth aspect of the present invention, in outputting only a characteristic event section, it is possible to output the characteristic event section using a CM section having been corrected. Accordingly, it is possible to prevent a CM section detected as a characteristic event section from being outputted.

According to the fifth aspect of the present invention, in outputting only a characteristic event section, it is possible to output the characteristic event section using a CM section having been corrected. Accordingly, it is possible to reduce the amount of characteristic event sections, detected as a CM section, being failed to be viewed.

According to the sixth aspect of the present invention, the width of shift performed for a boundary of a CM section can be selected in accordance with characteristics of the CM section. Accordingly, a fine and precise correction for the CM section becomes possible.

According to the seventh aspect of the present invention, the width of shift performed for a boundary of a CM section can be selected in accordance with the length of a program section immediately before the CM section. Accordingly, a fine and precise correction according to characteristics of a program becomes possible.

According to the eighth aspect of the present invention, the width of shift performed for a boundary of a CM section can be selected in accordance with a ratio of a program elapsed. Accordingly, a fine and precise correction according to an attribute of the program becomes possible.

According to the ninth aspect of the present invention, a minute CM section, in a program section, erroneously detected as a CM section can be erased, whereby, in viewing a program at the time of a CM skip reproduction, it is possible to prevent the program section from being missed out.

According to the tenth aspect of the present invention, the width of shift performed for a boundary of a CM section can be selected in accordance with a content of a program such as a genre of the program. Accordingly, a fine and precise correction according to an attribute/content of the program becomes possible.

Also, according to the eleventh to thirteenth aspects of the present invention, an effect similar to that in the first aspect of the present invention can be obtained.

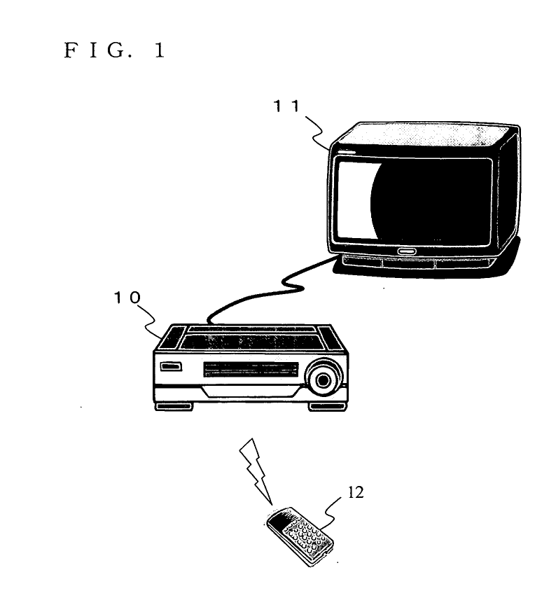

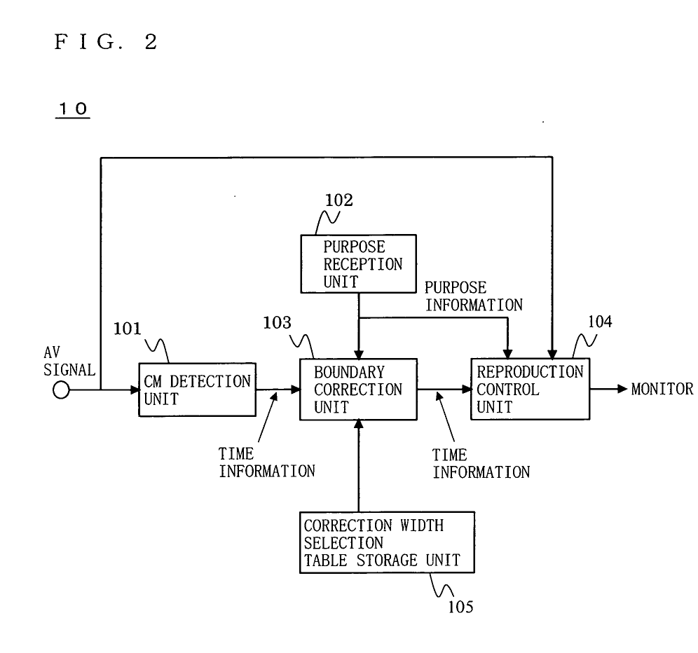

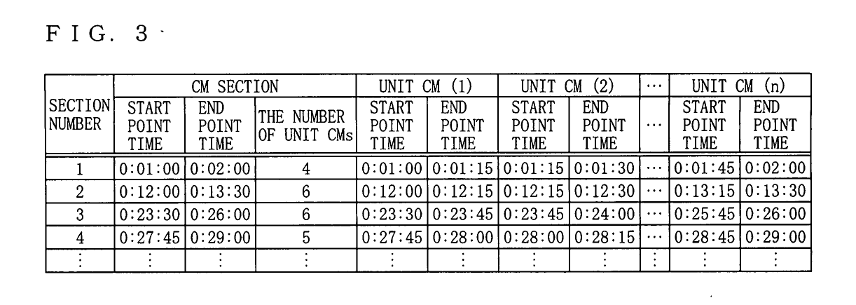

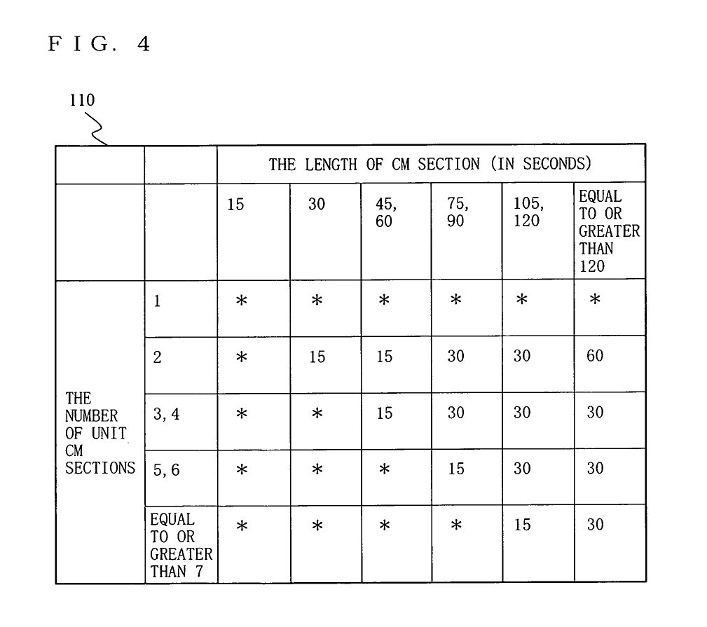

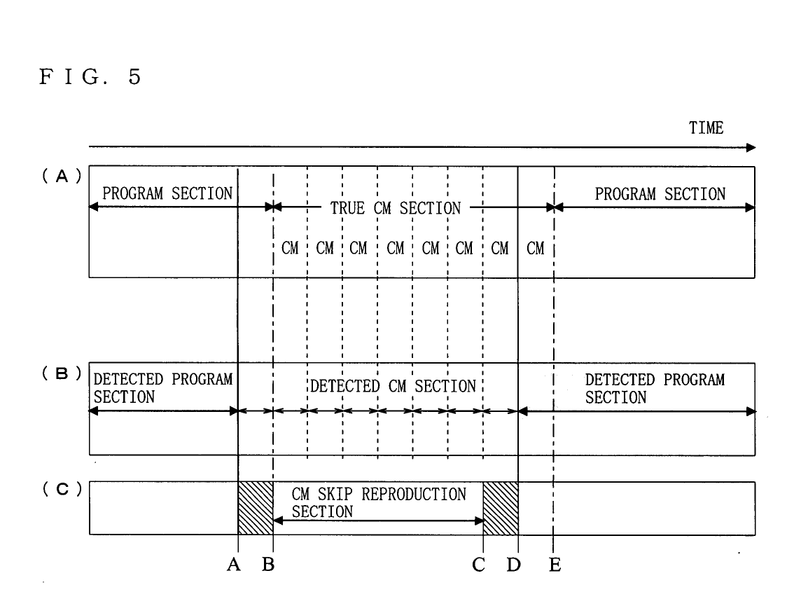

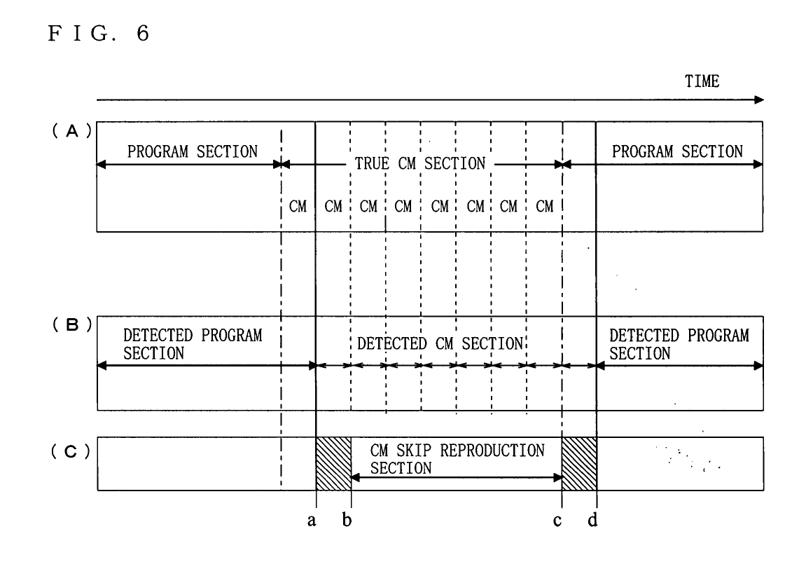

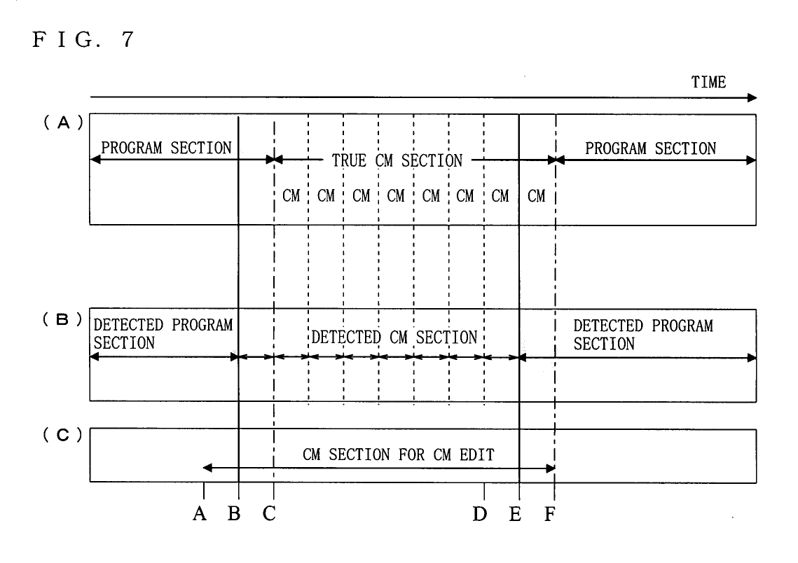

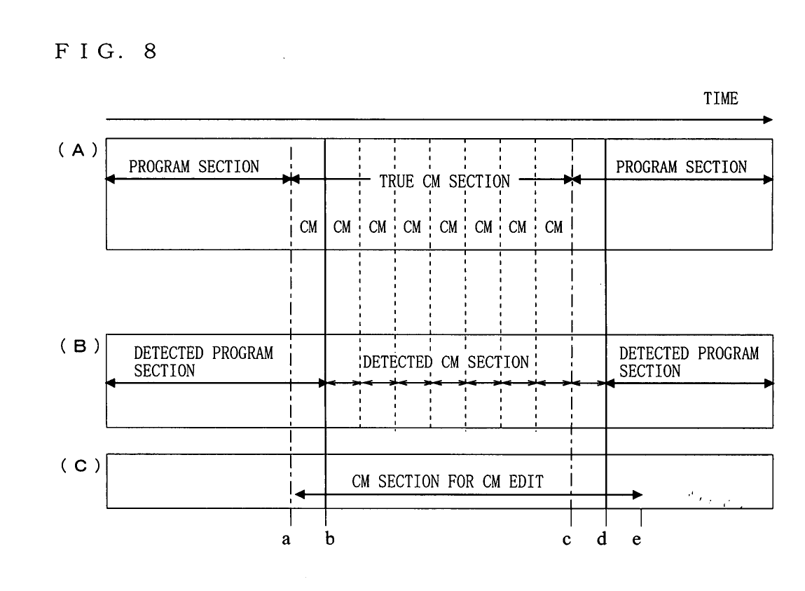

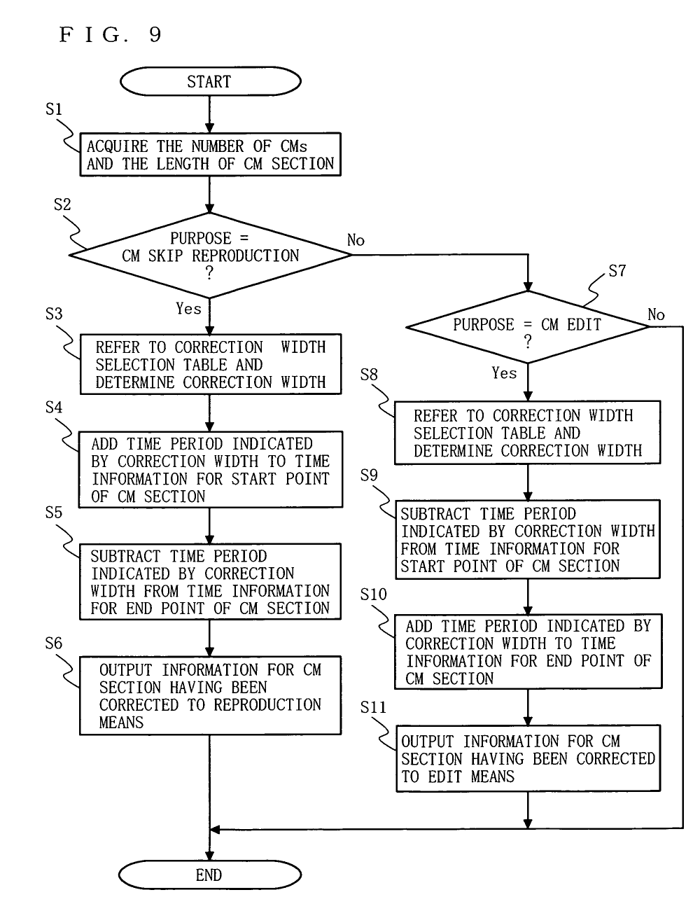

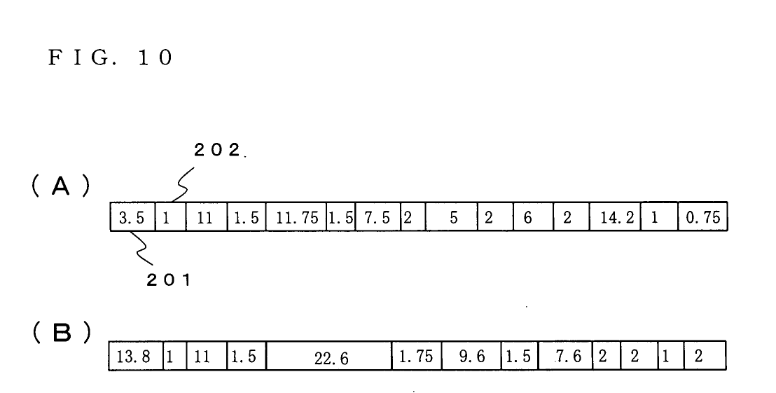

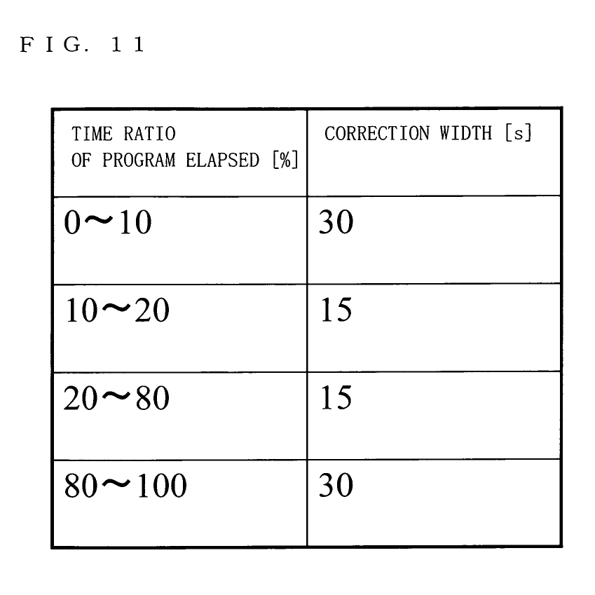

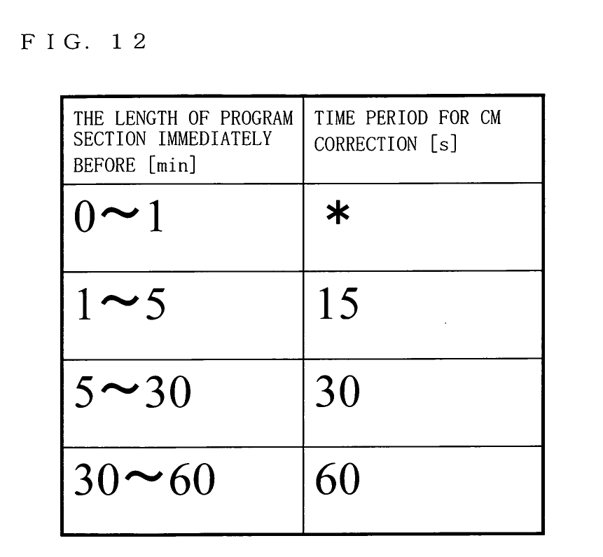

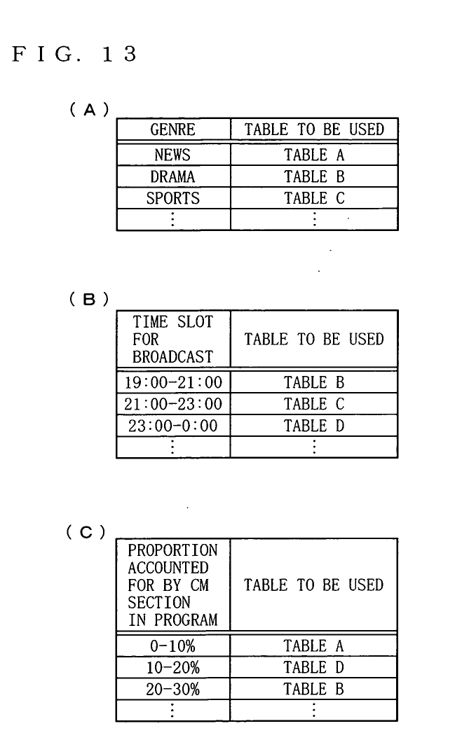

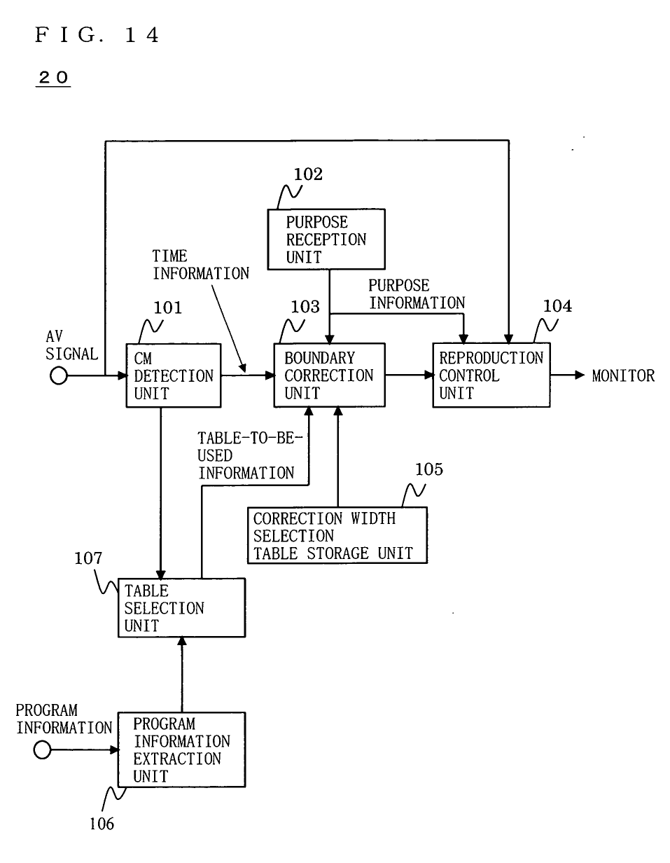

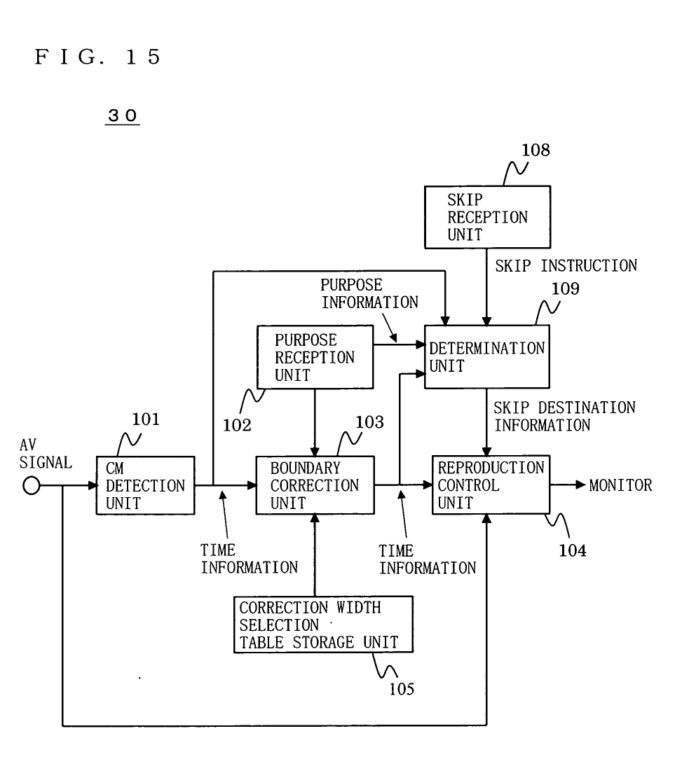

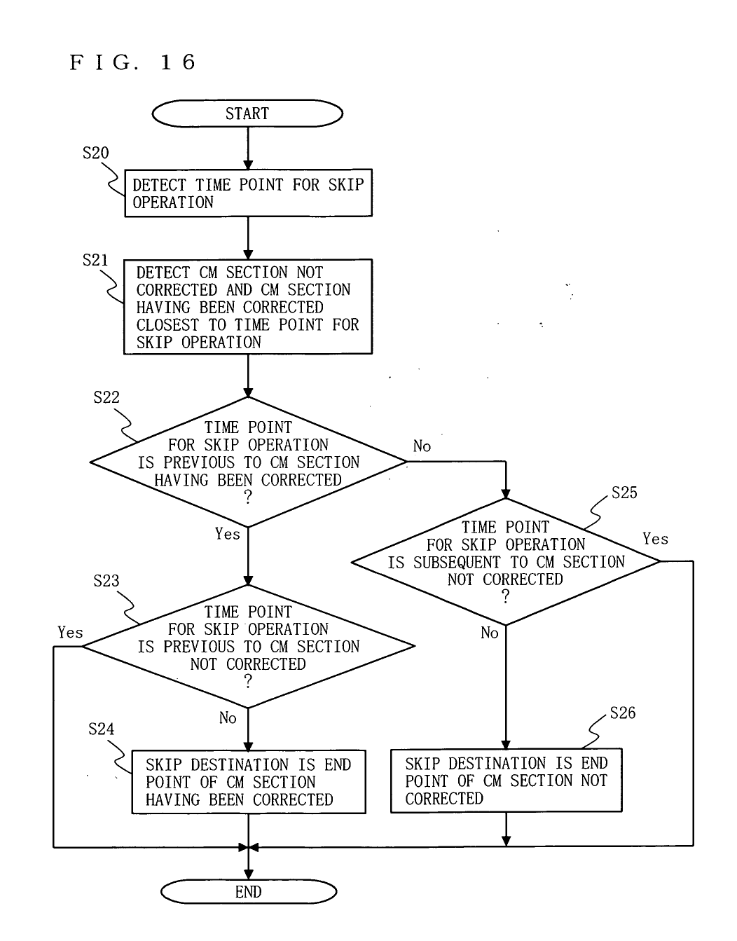

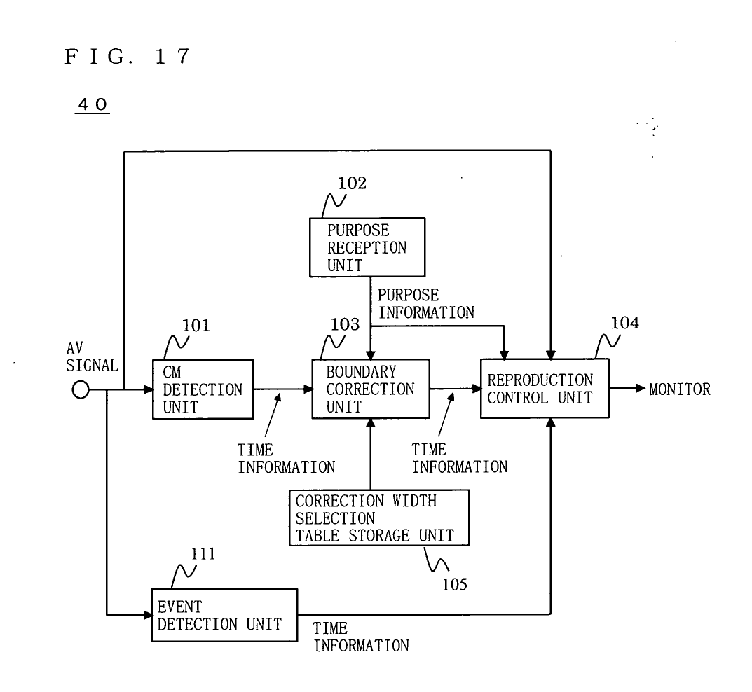

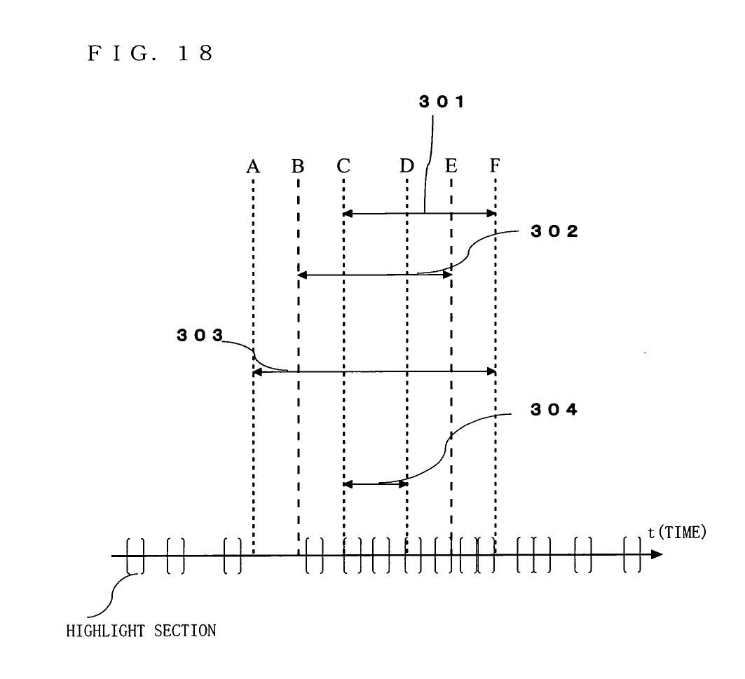

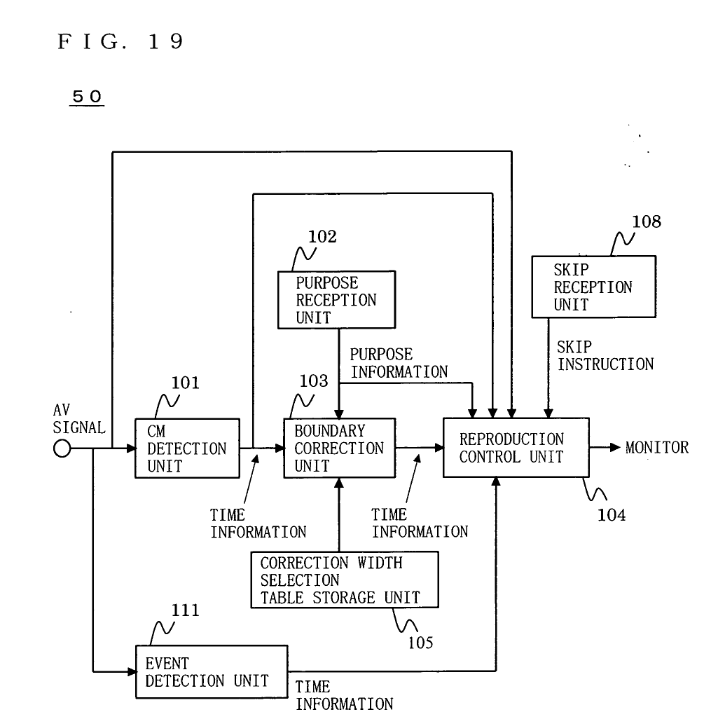

### BRIEF DESCRIPTION OF THE DRAWINGS

[FIG. 1] FIG. 1 is an outer view of an AV content edit reproduction device 10.

[FIG. 2] FIG. 2 is a block diagram showing a configuration of the AV content edit reproduction device 10.

[FIG. 3] FIG. 3 is a diagram showing an example of time information.

[FIG. 4] FIG. 4 is a diagram showing an example of a correction width selection table 110.

[FIG. 5] FIG. 5 is a diagram showing a true CM section, a CM section detected by a CM detection unit 101, and a CM section having been corrected by a boundary correction unit 103.

[FIG. 6] FIG. 6 is a diagram showing a true CM section, a CM section detected by the CM detection unit 101, and a CM section having been corrected by the boundary correction unit 103.

[FIG. 7] FIG. 7 is a diagram showing a true CM section, a CM section detected by the CM detection unit 101, and a CM section having been corrected by the boundary correction unit 103.

[FIG. 8] FIG. 8 is a diagram showing a true CM section, a CM section detected by the CM detection unit 101, and a CM section having been corrected by the boundary correction unit 103.

[FIG. 9] FIG. 9 is a flowchart showing a detail of a boundary correction process.

[FIG. 10] FIG. 10 is a diagram showing time periods for CMs inserted in a time frame for which a program is broadcasted.

[FIG. 11] FIG. 11 is a diagram showing an example of a table for selecting a correction width for a CM boundary based on an elapsed time with respect to an entire program in which a CM section is inserted.

[FIG. 12] FIG. 12 is an example of a correction width selection table for selecting a correction width in accordance with the length of a program section immediately before a CM is inserted.

[FIG. 13] FIG. 13 shows examples of selection tables for selecting a correction width selection table to be used.

[FIG. 14] FIG. 14 is a block diagram for an edit reproduction device 20 according to a second embodiment of the present invention.

[FIG. 15] FIG. 15 is a block diagram showing a configuration of an edit reproduction device 30 according to a third embodiment of the present invention.

[FIG. 16] FIG. 16 is a flowchart showing a detail of a determination process performed by a determination unit 109.

[FIG. 17] FIG. 17 is a block diagram showing a configuration of an edit reproduction device 40 according to a fourth embodiment of the present invention.

[FIG. 18] FIG. 18 is a diagram showing a portion of an AV content in which highlight sections H1 to 13 are detected.

[FIG. 19] FIG. 19 is a block diagram showing a configuration of an edit reproduction device 50 according to a fifth embodiment of the present invention.

[FIG. 20] FIG. 20 is a diagram schematically showing program sections and CM sections in a broadcast content.

[FIG. 21] FIG. 21 is a diagram showing an example of a CM section detection.

### DESCRIPTION OF THE REFERENCE CHARACTERS

10, 20, 30, 40, 50 edit reproduction device

11 monitor

12 remote control

101 CM detection unit

102 purpose reception unit

103 boundary correction unit

104 reproduction control unit

105 correction width selection table storage unit

106 program information extraction unit

107 table selection unit

108 skip reception unit

109 determination unit

110 correction width selection table

111 event detection unit

201 program section

202 CM section

301 true CM section

302 CM section detected by CM detection unit 101

303 CM section for program isolation and reproduction

304 CM section for highlight edit

### BEST MODE FOR CARRYING OUT THE INVENTION

Hereinafter, with reference to the drawings, embodiments of the present invention are described. Note that the present invention is not limited by the embodiments.

### FIRST EMBODIMENT

FIG. 1 is an outer view of an AV system including an AV content processing device 10 (hereinafter, referred to as an edit reproduction device) according to a first embodiment of the present invention. In FIG. 1, the edit reproduction device 10 is realized as, for example, a videotape recorder, a DVD recorder, or the like. In the edit reproduction device 10, sound and image information received by a reception section not shown is stored in a storage section not shown. The received sound and image information is decoded, and data which is compressed and encoded is decoded by a decode section not shown. A user uses a remote control 12 to operate the edit reproduction device 10.

FIG. 2 is a block diagram showing a configuration of the edit reproduction device 10. In FIG. 2, the edit reproduction device 10 includes a CM detection unit 101, a purpose reception unit 102, a boundary correction unit 103, a reproduction control unit 104, and a correction width selection table storage unit 105.

The CM detection unit 101 acquires, from an AV content (AV signal) inputted from the storage section not shown, boundary information indicative of boundaries between program sections and CM sections. Specifically, the CM detection unit 101 detects CM sections in the AV content by using, for example, the above-described switching time interval detection scheme. A method for detecting a CM section is not limited to a method using a change in a sound signal, and a method using an image signal is also employed. The CM detection unit 101 acquires time information (corresponding to the boundary information) indicating start points and end points of the detected CM sections, and outputs the time information to the boundary correction unit 103. The time information includes information indicative of the number of CMs (unit CM sections) included in each of the CM sections and a position of each of the unit CM sections. FIG. 3 is a diagram showing an example of time information. In FIG. 3, the time information includes information indicative of, for each of the CM sections, correspondence between a CM section, time of a start point, and time of an end point. Further, the time information shown in FIG. 3 includes information indicative of, for each unit CM section included in each of the CM sections, time of a start point and that of an end point. Here, time of a start point and an end point are indicated in reference to a start time of an AV content therefor (having zero for the start time of the AV content). Note that, the time information may be any information if the information indicates boundaries (time of a start point and an end point) for each unit CM section. In FIG. 3, each CM section in a stored content is assigned a section number. For example, a section between a time point one minute after the start of the program and a time point two minutes thereafter is detected as a CM section having a section number “1” in FIG. 3. Also, the CM section includes four unit CM sections, and information indicative of time of a start point/end point for each of the unit CM sections is also included.

The purpose reception unit 102 receives from the user an instruction for extracting and outputting a predetermined section in the AV content. Specifically, an instruction for performing a CM skip reproduction, detecting edit candidate points for editing a CM, or the like is received from the user. Such an instruction represents a purpose (intention) of the user in reproducing a broadcast content. In other words, the instruction for performing a CM skip reproduction (a program output instruction) represents a purpose of the user, i.e., “reproducing only program sections in the broadcast content”. Also, the instruction for detecting edit candidate points (a CM output instruction) represents a purpose of the user, i.e., “reproducing only CM sections in the broadcast content”. Namely, the purpose input unit is a unit for receiving a view purpose of the user in reproducing a broadcast content, the view purpose being, for example, a CM skip reproduction, a CM edit, or the like. Hereinafter, information indicative of a view purpose of the user such as the instruction described above is referred to as purpose information. Also, the purpose reception unit 102 outputs received purpose information to the boundary correction unit 103. In the present embodiment, the purpose reception unit 102 corresponds to the remote control 12, but, an input is not limited therefrom. For example, a sound input performed by a user can be received.

The boundary correction unit 103 corrects, in accordance with the purpose information outputted from the purpose reception unit 102, a content of the above-described time information obtained by the CM detection unit 101, and outputs the corrected time information to the reproduction control unit 104. In other words, the boundary correction unit 103 corrects a position of a CM boundary indicative of a boundary between a CM section and a program section. Also, in changing the time information, the boundary correction unit 103 reads out a correction width selection table 110 from the correction width selection table storage unit 105, and selects a time span (hereinafter, referred to as a “correction width”) to be changed.

There production control unit 104 reproduces an AV signal based on the purpose information outputted by the purpose reception unit 102 and the time information outputted by the boundary correction unit, and displays the reproduced AV signal on a monitor 11. Also, in a CM edit or the like described later, a screen, showing thumbnails for images or the like, used for an edit operation is displayed on the monitor 11.

The correction width selection table storage unit 105 stores the above-described correction width selection table 110. The correction width selection table storage unit 105 corresponds to a hard disk or a nonvolatile memory, for example.

Note that the CM detection unit 101 and the boundary correction unit 103 shown in FIG. 2 may typically be realized as an LSI, which is an integrated circuit. The CM detection unit 101 and the boundary correction unit 103 may be separately constructed in a chip form, or all or a portion thereof may be constructed in a chip form. Also, the method of integration for the circuit is not limited to LSI, and may be realized by a dedicated circuit or a general purpose processor.

Data used in the present embodiment is described next. FIG. 4 is a diagram showing an example of the correction width selection table 110 used for selecting a correction width described above. The correction width selection table 110 is generated in advance, and retained in the correction width selection table storage unit 105. In FIG. 4, the correction width selection table 110 shows correction widths having correspondence for the number of CMs and the lengths of CM sections. In other words, in the correction width selection table 110, a correction width is defined in accordance with the number of CMs and the length of a CM section. Here, the number of CMs refers to the number of unit CM sections included in a CM section. Also, the length of a CM section corresponds to a time length of the CM section, that is a time period obtained after subtracting a time of a start point from a time of an end point for the CM section. Note that, in FIG. 4, an asterisk (*) indicates not a correction for a position of a CM boundary but an erasure of a CM boundary.

Next, an outline of a process executed by the edit reproduction device 10 is described. Firstly, with reference to FIGS. 5 and 6, an outline of a process performed by the boundary correction unit 103 when a CM skip reproduction is selected as a view purpose is described. FIGS. 5 and 6 are diagrams showing an outline of a correction process performed by the boundary correction unit 103 in reproducing an AV content. Here, for the purpose of convenience, only a portion of the AV content to be reproduced is chosen for the description. In FIG. 5, graph (A) shows a configuration for true (actual) program sections and a CM section, and graph (B) shows a configuration for program sections and a CM section detected by the CM detection unit 101, and graph (C) shows a configuration for program sections and a CM section having been corrected by the boundary correction unit 103. In FIG. 5, a CM section (section A-D) detected by the CM detection unit 101 is so detected that the start point thereof is shifted backward with respect to a true CM section (section B-E). In other words, a portion of a program immediately before the true CM section is detected as a portion of a CM section. On the other hand, an end point D of the detected CM section is detected such that it is shifted forward with respect to the true CM section. In other words, a portion of the true CM section is detected as a portion of a program section.

If a CM skip reproduction is performed in accordance with the graph (B) shown in FIG. 5, the program portion (section AB) immediately before the true CM section is skipped. Therefore, the edit reproduction device 10 reduces the width of the CM section detected by the CM detection unit 101 so as to prevent the program section from being failed to be viewed.

Specifically, the boundary correction unit 103 shifts a start point A and the end point D of the CM section detected by the CM detection unit 101 in a direction in which the CM section is reduced by a predetermined time period (see the graph (C) shown in FIG. 5). The time span to shift, i.e., the correction width, is selected using the correction width selection table 110 (see FIG. 4). For example, if the number of unit CM sections is five and the length of a CM section is ninety seconds, the correction width is selected as fifteen seconds. The boundary correction unit 103 outputs, to the reproduction control unit 104, time information for the CM section having been corrected. The reproduction control unit 104 performs a CM skip reproduction based on the corrected time information for display on the monitor 11. Consequently, the program section is reproduced until point B, and a section between the point B and point C is skipped for being a CM section. Accordingly, it is possible to prevent the program portion (section AB) previous to the start of the CM from being failed to be viewed.

The asterisk (*) in the correction width selection table 110 shown in FIG. 4 represents a deletion of a CM boundary as described above. In other words, when a correction width is indicated with an asterisk, a CM section is not skipped and is reproduced with a speed same as a reproduction speed for a program section. In the correction width selection table 110 shown in FIG. 4, when the number of unit CM sections is small for the length of a CM section, an asterisk (*) is shown in a blank for indicating a correction width. There is a high possibility that a CM section in which the number of unit CM sections is small for the length of the CM section is actually a program section. In other words, when such a CM section is detected, there is a high possibility that a silence section in the program is wrongly detected as a CM section. Therefore, in order not to skip such a CM section but to reproduce it as a program section, the edit reproduction device 10 erases CM boundaries therefor.

Further, in contrast to a case of FIG. 5, FIG. 6 is a diagram showing that a CM section (section a-d) detected by the CM detection unit 101 is detected such that a start point and end point of a true CM section are shifted backward. In a case of FIG. 6, the boundary correction unit 103 corrects a position of a start point of the CM section from point a to point b and a position of an end point thereof from point d to point c (graph (C) shown in FIG. 6). Accordingly, it is possible to prevent a program portion (section cd) immediately after the true CM section from being failed to be viewed.

Next, with reference to FIGS. 7 to 8, an outline of a process performed in the edit reproduction device 10 when a CM edit is selected as a view purpose is described. Here, a CM edit refers to storing not a program but only CMs to a separate medium or the like. In performing a CM edit, in order to easily find a CM (unit CM section) which the user desires to record, the edit reproduction device 10 displays, on the screen in a thumbnail format, images corresponding to boundaries of CM sections or boundaries of unit CM sections in a CM section as edit candidate points. Then, the user selects an arbitrary candidate point from among edit candidate points displayed on the screen. Thereafter, the user manually performs a fine adjustment or the like for a position of a boundary of the CM, and then, to another medium, recording is performed for the CM which the user desires to record. In order to perform an operation such as described above, it is desired that CMs be not missed out when displayed in a manner of a thumbnail. In other words, it is necessary to eliminate a situation in which a CM is detected as a program despite being the CM and, as a result, the CM is not used for an edit candidate point and thus not displayed in a thumbnail.

FIG. 7 is a diagram showing an outline of a correction process performed by the boundary correction unit 103. In FIG. 7, graph (A) shows a configuration for true program sections and a CM section, graph (B) shows a configuration for program sections and a CM section detected by the CM detection unit 101, and graph (C) shows a configuration for program sections and a CM section having been corrected by the boundary correction unit 103. Similarly to the case of FIG. 5 described above, in FIG. 7, a CM section (section BE) is detected by the CM detection unit 101 such that a start point and end point thereof are shifted forward with respect to a true CM section (section CF). Accordingly, the last CM (section EF) in the true CM section is treated as a program section.

If a CM edit is performed in accordance with the graph (B) shown in FIG. 7, because a portion (section EF) corresponding to the last CM in the true CM section is treated as a program section, this last CM is missed out and not displayed in a thumbnail. Therefore, the edit reproduction device 10 increases the width of the CM section detected by the CM detection unit 101 so as not to miss out the last CM (section EF) in the CM section. In other words, in FIG. 7, both ends of the CM section detected by the CM detection unit 101 are shifted in a direction in which the CM section is increased by a predetermined time period (graph (C) shown in FIG. 7). A time span to shift, i.e., a correction width, is selected similarly to the case in the above-described CM skip reproduction. In other words, the boundary correction unit 103 refers to the correction width selection table 110, and selects a correction width in accordance with the number of unit CM sections and the length of the CM section. Then, the boundary correction unit 103 outputs corrected time information to the reproduction control unit 104. The reproduction control unit 104 searches for edit candidate points based on the corrected time information for display on the monitor 11. The user performs a CM edit operation such as described above, based on the edit candidate points. Accordingly, a CM which would not have been displayed as an edit candidate point according to the CM section not corrected is displayed as an edit candidate point, whereby it is possible to prevent the CM from being missed out in the edit operation by the user.

In contrast to a case of FIG. 7, in FIG. 8, a CM section (section b-d) is detected by the CM detection unit 101 such that a start point and end point thereof are shifted backward with respect to a true CM section (section a-c). If a CM edit is performed in accordance with graph (B) shown in FIG. 8, because a portion corresponding to a CM (section ab) immediately after the start of the true CM section is detected as a program section, this first CM is not displayed in a thumbnail as an edit candidate point. Therefore, the edit reproduction device 10 increases the width of the CM section in a similar manner to the case of FIG. 7 (graph (C) shown in FIG. 8). Consequently, the CM immediately after the start of the true CM section can also be displayed as an edit candidate point.

Next, with reference to FIG. 9, a detail of a boundary correction process performed by the boundary correction unit 103 is described. FIG. 9 is a flowchart showing a detail of the boundary correction process. In FIG. 9, firstly, the boundary correction unit 103 acquires, from time information outputted from the CM detection unit 101, information concerning the number of CMs and the length of a CM section (step S1). Next, the boundary correction unit 103 determines whether or not purpose information inputted from the purpose reception unit 102 by the user corresponds to a CM skip reproduction (step S2). If, according to the result, it is a CM skip reproduction (YES in step S2), the boundary correction unit 103 refers to the correction width selection table 110 so as to select a correction width based on the number of CMs and the length of the CM section (step S3). As shown in FIG. 4, in the correction width selection table, a correction width for shift is defined in accordance with the length of a CM section and the number of unit CM sections therein. For example, if the length of a CM section is ninety seconds and the number of unit CM sections therein is five, a correction width is selected as fifteen seconds. Next, the boundary correction unit 103 delays a start point of the CM section by the correction width selected in step S3 (step S4). Subsequently, the boundary correction unit 103 causes an end point of the CM section to be early by the correction width selected in step S3 (step S5). Consequently, as shown in the graph (C) of FIG. 5, time information is generated, and this time information is for the CM section which is corrected such that the width of the CM section detected by the CM detection unit 101 is reduced. If the correction width is selected as “*” in step S3, the boundary correction unit performs a process for erasing CM boundaries in steps S4 and S5. In other words, for a CM section determined such that CM boundaries thereof are to be erased, time for a start point and an end point that are included in the time information are deleted. Also, time for start points and end points of unit CM sections included in the CM section are deleted. Subsequent to step S5, the boundary correction unit 103 outputs the corrected time information to the reproduction control unit 104 (step S6).

On the other hand, if, according to the result of the determination in step S2, the purpose information does not correspond to a CM skip reproduction (NO in step S2), the boundary correction unit 103 determines whether or not the purpose information is a CM edit (step S7). If, according to the result, it is not a CM edit (NO in step S7), the boundary correction process is ended. On the other hand, if it is a CM edit (YES in step S7), the boundary correction unit 103 refers to the correction width selection table 110 so as to select a correction width based on the length of the CM section and the number of unit CM sections (step S8). Here, for the sake of convenience in description, it is assumed that the correction width is selected as fifteen seconds. Based on the selected correction width, the boundary correction unit 103 causes a start point of the CM section to be early by fifteen seconds (step S9). Subsequently, the boundary correction unit 103 delays an end point of the CM section by fifteen seconds (step S10). Consequently, as shown in the graph (C) of FIG. 7 and the graph (C) of FIG. 8, information is generated, and this information is for the CM section which is corrected such that the width of the CM section detected by the CM detection unit 101 is increased. Then, the boundary correction unit 103 outputs, to the reproduction control unit 104, the time information for the CM section having been corrected (step S11). With the above, the boundary correction process performed by the boundary correction unit 103 is ended.

As such, in the first embodiment, it is possible to correct positions of a start point and end point of a detected CM section in accordance with a user's purpose for viewing an AV content. As a result, it is possible to prevent a portion desired by the user for viewing from being missed out, the miss being due to an erroneous detection of a portion of a CM section. In other words, it is possible to reduce unpleasantness caused, to the user, by reproducing an erroneously detected CM section or the like.

### SECOND EMBODIMENT

Next, with reference to FIGS. 10 to 14, a second embodiment of the present invention is described. In the first embodiment, only one type of the correction width selection table 110 is in use. In the second embodiment, a correction width selection table is not limited to one type, and a plurality of types of correction width selection tables are used.

Firstly, a variation of a correction width selection table used in the second embodiment is described. Positions and lengths of program sections and CM sections to be inserted in a program differ according to a genre or a content of the program. FIG. 10 shows diagrams showing examples of positions and lengths of program sections 201 and CM sections 202 in a news program and a variety program. Graph (A) of FIG. 10 is an example of a news program, and graph (B) is an example of a variety program. Each numerical value in FIG. 10 shows a time period (in minutes) for each section. In FIG. 10, programs broadcasted in a same time frame are shown. However, the number of times the CM section 202 inserted and the length of the CM section per one insertion are different between the programs. Consider first CM sections inserted after the programs started. A time duration for each of the first CM sections is short, being one minute. Similarly, a time duration for each of the last CMs inserted before the programs end is short, being one minute. Time durations for CM sections inserted in the middle of the programs are long, compared to the CM sections inserted in the beginning of the programs and that inserted in the end of the programs. Accordingly, it can be thought that a correction width selection table is to be prepared focusing on a position, of an inserted CM section, represented by an elapsed time ratio of the inserted CM section to the program. In other words, it can be thought that a correction width selection table (hereinafter, referred to as an “elapse ratio table”) is used for selecting a correction width in accordance with a position, indicated in percentage, indicative of where a time band for which a CM section is inserted is located in an entire time band for a program in view of the time elapsed in the program. FIG. 11 is an example of an elapse ratio table. In FIG. 11, for example, a correction width for a CM section inserted at the beginning (5%) of a program is shown to be thirty seconds. For a CM section inserted when the program proceeds to about a halfway (50%) point, a correction width therefor is shown to be fifteen seconds.

Further, it can be thought that a correction width may be selected focusing on the length of a program section immediately before a CM section. If a program section immediately before a CM section is extremely short, e.g., one second, there is a high possibility that a portion of the CM section is erroneously detected as the program section. In such a case, a boundary between the CM section and the program section is erased because it is desirable that the program section be included in the CM section, or the like. FIG. 12 is an example of a correction width selection table (hereinafter, referred to as a “section-immediately-before table”) for selecting a correction width in accordance with the length of a program section immediately before a CM section. Note that, as described above, “*” in the figure indicates that a CM section is to be deleted. In FIG. 12, for example, when a program section immediately before a CM section is less than one minute, a boundary of the CM section is deleted.

Further, it can be thought that a correction width selection table to be used is changed in accordance with a genre of a program or a time slot for broadcast the program, or further alternatively, a proportion accounted for by CM sections in the program. This is said when the followings are considered. That is, even for programs broadcasted in a same time frame, e.g., one hour, the number of CM sections inserted in the programs and the number of unit CM sections inserted in one CM section are different depending on a time slot used for broadcast or a genre of the programs; the length of each broadcasted CM section differs depending on a time slot because an advertisement fee for broadcast a CM varies with a time slot; further, a proportion accounted for by CM sections in the program are different for each program. FIG. 13 shows examples of table-to-be-used selection tables (hereinafter, referred to as “selection tables”) for selecting a correction width selection table to use, in accordance with a genre of a program, a time slot for broadcast, and a proportion of CM sections, respectively. In FIG. 13, selection table (A) shows correspondence between a genre of a program and a correction width selection table to be used. Similarly, selection table (B) shows correspondence between a time slot for broadcast and a correction width selection table, and selection table (C) shows correspondence between a proportion accounted for by CM sections in a program and a correction width selection table. In a case where the selection table (A) is used, when, for example, a genre of a program is news, correction width selection table A is used. When the genre of the program is drama, correction width selection table B is used, and, when the genre of the program is sports, correction width selection table C is used. Although not shown here, each correction width selection tables A, B, C, and D in FIG. 13 corresponds to a table, i.e., the correction width selection table 110, described using FIG. 4 in the above first embodiment, in which values for correction widths set for the number of CMs and the length of a CM are changed. Surely, not only the correction width selection table shown in FIG. 4, but also the aforementioned elapse ratio table or the section-immediately-before table may be used for a table corresponding to the selection table.

FIG. 14 is a block diagram for an edit reproduction device 20 according to the second embodiment of the present invention. In FIG. 14, the edit reproduction device 20 corresponds to a functional configuration of the edit reproduction device 10, described with reference to FIG. 2 in the above first embodiment, added with a program information extraction unit 106 and a table selection unit 107. The configuration sections other than those added are similar to those in the first embodiment. Accordingly, except the program information extraction unit 106 and the table selection unit 107, the configuration sections are assigned the same reference numerals, and the detailed description therefor is omitted.

In FIG. 14, the program information extraction unit 106 acquires information (hereinafter, referred to as “program information”) concerning a program transmitted via a communication line or the internet, or alternatively, a program received by a reception section not shown. The program information is used to select a correction width selection table to be used such as described above. An example of the program information is an EPG in which a title, a broadcast time, a genre, names of TV personalities to be on, a synopsis, and the like of a program are described. The program information extraction unit 106 outputs the acquired program information to the table selection unit 107.

Further, in FIG. 14, the correction width selection table storage unit 105 stores a plurality of correction width selection tables such as an elapse ratio table and section-immediately-before table described above.

The table selection unit 107 selects a correction width selection table to be used by the boundary correction unit 103, based on the program information acquired by the program information extraction unit 106. Then, the table selection unit 107 notifies the boundary correction unit 103 of the selected correction width selection table 110. For example, the table selection unit 107 firstly acquires information concerning a genre from the above program information. Then, by using a selection table such as shown in FIG. 13 (A) described above, a table to be used by the boundary correction unit 103 is selected. Note that the selection table may be possessed by the table selection unit 107, or retained in the correction width selection table storage unit 105 for the table selection unit 107 to read out as necessary. When information concerning a broadcast time slot is acquired from the program information, a correction width selection table to be used by the boundary correction unit 103 is selected by using the selection table shown in FIG. 13(B). When, supposedly, information concerning a genre or a broadcast time slot cannot be acquired from the program information, the table selection unit 107 calculates a proportion accounted for by CM sections in the program based on the information for CM sections detected by the CM detection unit 101. Then, by using the selection table shown in FIG. 13(C), the table selection unit 107 may select a table to be used by the boundary correction unit 103 in accordance with the proportion accounted for by the CMs.

As described above, in the second embodiment, a plurality of correction width selection tables are prepared according to a genre of a program or the like, and a correction width selection table to be used is chosen as appropriate in accordance with program information (e.g., genre information or the like) acquired by the program information extraction unit 106. Accordingly, it is possible to perform a fine adjustment for a correction width for a CM boundary in accordance with a content of the program.

With regard to a CM inserted immediately after a program portion, some programs have the CM inserted before a highlight so that a user feels like viewing the next. On the other hand, other programs such as news are produced such that a topic is closed before it switches to a CM. In other words, some programs have an association between a program portion immediately before a CM and a program portion immediately after the CM in terms of information to be broadcasted, and other programs have no associations therebetween. Therefore, a correction width selection table may be previously prepared for each discrete program or arranged such that a user can set. For example, when an association between program contents before and after a CM is poor, it can be thought that a table for large correction widths is prepared. Then, a correction width selection table may be chosen as appropriate for each discrete program. As such, it becomes possible to select a correction width in accordance with an association between program contents before and after a CM section in each program, and thus to perform a finer adjustment.

### THIRD EMBODIMENT

Next, with reference to FIGS. 5, 6, 15, and 16, a third embodiment of the present invention is described. In the first embodiment described above, in a case where an outset portion (section cd) of a program section is detected as a CM section when using, for example, a CM section detected by the CM detection unit 101 and is shown in the graph (B) of FIG. 6, the width of the CM section is reduced so as to prevent the outset portion of the program from being missed out. However, after the reduction, an outset of a CM (section ab) in the CM section is recognized as a program section. Accordingly, when a program section (a first half) prior to the CM section detected by the CM detection unit 101 is ended, the outset portion (section ab) of the CM section is not skipped and is reproduced as a portion of the program section. In the third embodiment, when a CM recognized as a portion of a program section is reproduced, a user performs a skip instruction so as to skip the reproduction to the end point of the CM section.

FIG. 15 is a block diagram showing a configuration of an edit reproduction device 30 according to the third embodiment of the present invention. In FIG. 15, the edit reproduction device 30 corresponds to a functional configuration of the edit reproduction device 10, described with reference to FIG. 2 in the above described first embodiment, added with a skip reception unit 108 and a determination unit 109. The configuration sections other than those added are similar to those in the first embodiment. Accordingly, except the skip reception unit 108 and the determination unit 109, the configuration sections are assigned the same reference numerals, and the detailed description therefor is omitted. Note that, the CM detection unit 101, the boundary correction unit 103, and the determination unit 109 shown in FIG. 15 may typically be realized as an LSI, which is an integrated circuit.

In FIG. 15, the skip reception unit 108 corresponds to the remote control 12 and, upon receipt of an input of a skip instruction from a user, outputs the instruction to the determination unit 109. The determination unit 109 acquires, from the CM detection unit 101, time information for a CM section not corrected. Also, the determination unit 109 acquires, from the boundary correction unit 103, time information for the CM section having been corrected. Also, the determination unit 109 acquires, from the purpose reception unit 102, the above-described purpose information. When receiving the skip instruction from the skip reception unit 108, the determination unit 109 identifies a skip destination using the time information not corrected, the time information having been corrected, and the purpose information, and outputs, to the reproduction control unit 104, time information (hereinafter, referred to as “skip destination information”) for the skip destination.

Next, referring back to FIGS. 5 and 6 described above, an outline of operations for a skip instruction in the third embodiment is described. Firstly, described is a case where a CM section is so detected that it is shifted backward with respect to a true CM section, as shown in the graph (B) of FIG. 6. In this case, by performing a correction of reducing the width of the CM section, it was possible to prevent a program section (section cd) corresponding to the ending of the CM section not corrected from being missed out. On the other hand, due to the backward shift performed for the start point of the CM section, a CM (section ab) immediately before the CM section (section bc of the graph (C) shown in FIG. 6) having been corrected is reproduced as a program section. Here, a skip button is pressed while the CM (section ab) is being reproduced, and the reproduction is skipped to an outset (point c) of a next program section. When a CM section is so detected, by the CM detection unit 101, that it is forward shifted with respect to a true CM section, as shown in the graph (B) of FIG. 5, a CM (section CD) is displayed even after a CM section (section BC of the graph (C) shown in FIG. 5) having been corrected is skipped. Here, when a skip operation is performed while the CM (section CD) is being displayed, the reproduction is skipped to an end point (point D) of the CM section not corrected.

Next, described is a detail of a determination process performed by the determination unit 109 when a user performs a skip operation during a CM reproduction such as described above. FIG. 16 is a flow chart showing a detail of the determination process performed by the determination unit 109 when a skip operation is performed. In FIG. 16, firstly, the determination unit 109 detects a position, in an AV content currently under reproduction, corresponding to a time point (hereinafter, referred to as a “skip instruction time point”) at which the skip operation is performed (step S20). Next, the determination unit 109 detects positions (time for start points and end points) of both a CM section not corrected and a CM section having been corrected which are closest to the skip instruction time point (step S21).

Next, the determination unit 109 determines whether the skip instruction time point is before or after the position of the CM section detected in step S21 and having been corrected (step S22). If, according to the result, the skip instruction time point is at a position before the CM section having been corrected (YES in step S22), it is determined whether or not the skip instruction time point is previous to the CM section which is detected in step S21 and not corrected (step S23). If, according to the determination result, the skip instruction time point is previous to the CM section not corrected (YES in step S23), the process is ended because this indicates that the skip instruction is performed during the reproduction of a program section. In other words, skipping is not performed. On the other hand, if the skip instruction time point is previous to the position of the CM section not corrected (NO in step S23), it can be thought that the skip operation is performed during the reproduction of the section ab shown in the graph (C) of FIG. 6. Therefore, the determination unit 109 determines that the reproduction should be skipped to the end point of the CM section having been corrected. In other words, it is determined that the skip destination is the end point (point c) of the CM section having been corrected (step S24). Then, the determination unit 109 outputs the skip destination information to the reproduction control unit 104. The reproduction is skipped to the point c based on the skip destination information, and the reproduction control unit 104 reproduces a content following thereafter. Accordingly, when a user performs a skip operation during a CM being displayed, the reproduction is skipped to an end point of a CM section having been corrected, and a program following to a completion of the CM section is immediately displayed.

On the other hand, if, according to the determination result in step S22, it is determined that the skip instruction time point comes after the CM section having been corrected (NO in step S22), it is then determined whether or not the skip instruction time point is subsequent to the position of the CM section which is detected in step S21 and not corrected (step S25). If, according to the result, the skip instruction time point is subsequent to the position of the CM section not corrected (YES) in step S25), the process is ended because this indicates that the skip instruction is performed during the reproduction of a program section. In other words, skipping is not performed. On the other hand, if the skip instruction time point is previous to the position of the CM section not corrected (NO in step S25), it can be thought that the skip operation is performed during the section CD of the graph (C) of FIG. 5 (during the reproduction of the CM which follows immediately after a completion of the CM section having been corrected). In this case, the determination unit 109 determines that the reproduction should be skipped to the end point (end point D of the graph (C) shown in FIG. 5) of the CM section not corrected (step S26). In other words, it is determined that the skip destination is the end point of the CM section not corrected. Then, the determination unit 109 outputs the skip destination information to the reproduction control unit 104. Accordingly, when the user performs a skip operation during the reproduction of a CM in the section CD, the reproduction is skipped to the end point D of the CM section not corrected.

As such, in the third embodiment, it is possible that the reproduction is skipped to an end point of a not corrected or corrected CM section through a skip instruction from a user. Accordingly, a program section is not failed to be viewed and a CM can be skipped with an easy operation, and thereby being able to provide the user an AV content to be viewed with pleasantness.

### FOURTH EMBODIMENT

Next, with reference to FIGS. 17 and 18, a fourth embodiment of the present invention is described. In the fourth embodiment, a characteristic event section is extracted from an AV content and then outputted. Here, when the characteristic event section is a CM section, the characteristic event section is treated as a CM section and caused not to be outputted.

A characteristic event section refers to a section having a meaningful coherence in acoustic characteristics or image characteristics. In terms of acoustic characteristics, a characteristic event section corresponds to a section having a coherence in sounds such as speech sound, music, or jingle, or alternatively, a section having a coherence in sounds such as a siren, that have a specific signification, for example. In terms of image characteristics, an attention is given to an image such as a subtitle, a person, or a face having a signification, and the characteristic event section corresponds to a section for which the above meaningful image can be detected as having a coherence, or to a section which, when a change in movement caused by a cut or by camera work has a signification, can be detected by focusing on the change in the movement. Also, the characteristic event section includes a combination of the above-described acoustic characteristics and image characteristics.

Hereafter, the description is provided assuming that an example of a characteristic event section is a highlight section such as a scene on which a goal is scored in soccer while the game is broadcasted. It is assumed that a detection of the highlight section is performed by focusing on cheers. For example, in sports broadcast, a great cheer generally occurs on a scene where a goal is scored in soccer, a home run is hit in baseball, and the like. Therefore, if cheers are equal to or greater than a predetermined threshold in magnitude, a scene on which the cheers occur can be detected as a highlight section. Cheers can be detected by conducting a frequency analysis, then comparing power levels for a specific band, and then detecting a portion for which a power level is continuously equal to or greater than the predetermined threshold. Using the detected portion, a highlight section is detected, and, by reproducing the detected section, a content of the AV content can be grasped in a short time period. Hereinafter, such a reproduction is referred to as an isolation reproduction.

FIG. 17 is a block diagram showing a configuration of an edit reproduction device 40 according to the fourth embodiment of the present invention. In FIG. 17, the edit reproduction device 40 corresponds to a functional configuration of the edit reproduction device 10, described with reference to FIG. 2 in the above described first embodiment, added with an event detection unit 111. The configuration sections other than that added are similar to those in the first embodiment. Accordingly, except the event detection unit 111, the configuration sections are assigned the same reference numerals, and the detailed description therefor is omitted. In FIG. 17, the event detection unit 111 detects, in an AV signal (AV content), a characteristic event section such as described above. Also, the event detection unit 111 outputs, to the reproduction control unit 104, time information indicative of a position of the characteristic event section in a program. The reproduction control unit 104 outputs an AV signal to a monitor, based on time information for a CM section which has been corrected and inputted from the boundary correction unit 103 and the time information for the characteristic event section. Note that the CM detection unit 101, the boundary correction unit 103, and the event detection unit 111 shown in FIG. 17 may typically be realized as an LSI, which is an integrated circuit.

Next, described with reference to FIG. 18 is a process of an isolation reproduction performed in the edit reproduction device 40 when the isolation reproduction is instructed from the purpose reception unit 102. FIG. 18 is a diagram showing a portion of an AV content for which highlight sections of Hi to H13 are detected by the event detection unit 111 for an isolation reproduction. In FIG. 18, a section limited by points C-F is a true CM section 301. A section limited by points B-E is a CM section 302 detected by the CM detection unit 101. A section limited by points A-F is a CM section 303 having been corrected for an isolation reproduction. Also, a section limited by points C-D is a CM section 304 having been corrected for a highlight edit described later.

A highlight section is detected using a magnitude of power level as described above. Therefore, in FIG. 18, when there is a section where a power level is large, the section is detected as a highlight section even if it is in the true CM section 301. In other words, detected highlight sections are indistinguishable from a CM section or a program section.

However, in an isolation reproduction, a purpose of a user is to grasp a content of a program in a short time period. Therefore, it is important that a highlight section is extracted without having a useless portion. Nevertheless, when an isolation reproduction is simply performed for a highlight section detected as above, a CM detected as the highlight section is included. Reproducing such a CM in an isolation reproduction is equivalent to reproducing a useless portion for the user, and therefore, it defeats the purpose of grasping a content of a program in a short time period. Accordingly, it can be thought that the CM section 302 detected by the CM detection unit 101 is to be excluded from a target for searching a highlight section. In other words, the reproduction control unit 104 removes a section corresponding to the CM section in the highlight section and reproduces the obtained highlight section. However, in this case also, the CM detection unit 101 cannot perfectly detect a position of the CM section, and therefore, there is a possibility that a highlight section (H9 or H10 in FIG. 18) detected as a program section despite being a CM is reproduced.

Therefore, the boundary correction unit 103 shifts a start point and an end point of the CM section 302 (section BE) detected by the CM detection unit 101 toward program section sides. In other Words, the width of the CM section is increased (the CM section 303). The amount of the shift, namely, a correction width, is selected in a similar manner to that described in the above first embodiment. Then, the boundary correction unit 103 outputs, to the reproduction control unit 104, time information for the CM section 303 having been corrected. As such, a unit CM section (section EF), which the CM detection unit 101 could not detect, can be included in the CM section. Then, the reproduction control unit 104 reproduces the highlight section after removing, from the highlight section, sections included in the CM section 303 having been corrected. Accordingly, it is possible to prevent a highlight in a CM from being detected and reproduced as a highlight section in a program.

As described above, in the fourth embodiment, it is possible to detect and remove, from a characteristic event section such as a highlight section, a CM section having characteristics similar to a highlight section. As such, it is possible to prevent a highlight section (CM section) which is unnecessary for the user from being reproduced in an isolation reproduction.

### FIFTH EMBODIMENT

Next, with reference to FIGS. 17 and 18, fifth embodiment of the present invention is described. In the fifth embodiment, an AV content is used for a view purpose of editing a highlight in a program section. In a highlight edit, highlight sections are extracted from an AV content, and the extracted highlight sections are displayed, on a screen, in thumbnails. A user selects a favorite highlight scene from the thumbnails and records the selected highlight scene to a separate medium.

An edit reproduction device 50 according to the fifth embodiment of the present invention corresponds to a functional configuration of the edit reproduction device 40, described with reference to FIG. 17 in the above described fourth embodiment, added with a skip reception unit 108. The configuration sections other than that added are similar to those in the fourth embodiment. Except the skip reception unit 108, the configuration sections are assigned the same reference numerals, and the detailed description therefor is omitted. The skip reception unit 108 corresponds to the remote control 12, receives a skip instruction inputted from the user, and outputs the instruction to the reproduction control unit 104.

Next, referring back to the above-described FIG. 18, a highlight edit process according to the fifth embodiment is described. As described above, FIG. 18 shows that a state in which highlight sections, i.e., H1 to H13, are detected by the event detection unit 111. Also, in FIG. 18, the true CM section 301 is section CF, and the CM section 302 detected by the CM detection unit 101 is section BE. Accordingly, highlight section H4 is treated as a highlight section in a CM section despite being a highlight section in a program. Consequently, when highlight sections are displayed after removing the CM section 302 detected by the CM detection unit 101 in order to display the highlight sections in the program in thumbnails, H4 does not appear in the thumbnails. Accordingly, H4 will not be a target for a highlight edit despite being a highlight scene in a program section. Therefore, in order to display H4 in a thumbnail, the boundary correction unit 103 reduces the width of the CM section 302 (section BE) detected by the CM detection unit 101 to be section CD so that the CM section for highlight edit 304 is obtained. This process is similar to the process in the first embodiment. Then, the boundary correction unit 103 outputs, to the reproduction control unit 104, time information for the CM section for highlight edit 304. The reproduction control unit 104 removes, from highlight sections outputted from the event detection unit 111, sections included in the CM section for highlight edit 304, and then displays the obtained highlight sections on the monitor 11 in thumbnails. Consequently, on the monitor 11, highlight sections H1 to H4 and H7 to H13 are displayed in thumbnails. In other words, H4 which would not have been displayed according to a detection result of the CM detection unit 101 is displayed.

Next, assume that the user selects H7 from a thumbnail display displayed on the monitor. H7 is originally included in the CM section 302 detected by the CM detection unit 101. Accordingly, when the user views this highlight section, the user determines that the section is a CM and therefore unnecessary. Then, the user gives an instruction that he/she does not want the section (skip instruction) via the skip reception unit 108. The reproduction control unit 104 deletes H7 (information concerning H7) from a group of highlight sections (a group of highlight sections for edit candidates) to be displayed in thumbnails. Also, here, the reproduction control unit 104 refers to time information for the CM section 302 not corrected, and deletes H8 included in the CM section 302 together with H7. Then, time information for next H9 is outputted to the reproduction control unit 104. The reproduction control unit 104 starts reproducing H9 and outputs H9 to the monitor 11. In other words, a highlight section is evaluated as unnecessary when the highlight section follows to a highlight section being displayed at the time of receiving from the user a skip instruction and included in the CM section 302 not corrected. Consequently, the highlight section is deleted from edit candidates by the reproduction control unit 104.

Accordingly, in the fifth embodiment, it is possible that, in a view purpose of a highlight edit, the amount of edit candidates of highlight sections being missed is reduced by correcting boundaries for CM sections. Also, even when a CM section is erroneously detected and reproduced as a highlight section, the user can delete the detected highlight section corresponding to the CM section with an easy operation. As a result, it is possible to provide the user a pleasant environment for editing.

Note that each of the above-described embodiments may be provided in a form of a program to be executed by a computer. In this case, an edit reproduction program stored in a storage section (not shown) in an edit reproduction device is read, and a control section (not shown) may execute the process such as described in the above.

### INDUSTRIAL APPLICABILITY

An AV content edit reproduction device, an edit reproduction method, an edit reproduction program, and an edit reproduction circuit of the present invention can correct positions of boundaries for detected CM sections and are useful for use for an equipment or the like, such as a hard disk recorder and a DVD recorder, for viewing an AV content.

1. An AV content processing device for outputting at least a portion of an AV content including a program section and a CM section, comprising:
an acquisition unit for acquiring boundary information indicative of a boundary between the program section and the CM section;
a first reception unit for receiving from a user an instruction for extracting and outputting a predetermined section in the AV content;
a boundary correction unit for selecting, in accordance with the instruction received by the first reception unit, whether the boundary is shifted in a direction for the CM section to be short or long, and correcting a content of the boundary information such that the boundary is shifted in accordance with the selected direction; and
an output control unit for determining, when the instruction is received by the first reception unit, the boundary between the program section and the CM section in accordance with the corrected boundary information, and extracting and outputting a section indicated by the instruction.

2. The AV content processing device according to claim 1, wherein
the first reception unit is operable to receive from the user a program output instruction for outputting at least a portion of the program section of the AV content and a CM output instruction for outputting at least a portion of the CM section of the AV content,
the boundary correction unit corrects the content of the boundary information such that the boundary is shifted in the direction for the CM section to be short when the program output instruction is received by the first reception unit, and corrects the content of the boundary information such that the boundary is shifted in the direction for the CM section to be long when the CM output instruction is received by the first reception unit, and
the output control unit extracts and outputs, when the program output instruction is received by the first reception unit, a section indicated as a program section according to the corrected boundary information, and extracts and outputs, when the CM output section is received by the first reception unit, a section indicated as a CM section according to the corrected boundary information.

3. The AV content processing device according to claim 2 further comprising a second reception unit for receiving from the user a skip instruction for skipping a portion of the AV content being outputted by the output control unit, wherein,
when the skip instruction is received by the second reception unit during an output of the AV content between a boundary indicating a start point of a CM section according to the boundary information not corrected and a boundary indicating a start point of the CM section according to the boundary information having been corrected, the output control unit causes the output of the AV content to be skipped to an end point of the CM section according to the boundary information having been corrected, and, when the skip instruction is received by the second reception unit during an output of the AV content between a boundary indicating an end point of the CM section according to the boundary information not corrected and a boundary indicating the end point of the CM section according to the boundary information having been corrected, causes the output of the AV content to be skipped to the end point of the CM section according to the boundary information not corrected.

4. The AV content processing device according to claim 1 further comprising a detection unit for calculating a parameter indicating characteristics of one of a sound and an image in the AV content and detecting a section for which the parameter satisfies a predetermined condition as a characteristic section, wherein
the reception unit is operable to receive from the user a characteristics output instruction for extracting and outputting the characteristic section in the program section,
the boundary correction unit corrects, when the characteristics output instruction is received by the first reception unit, the content of the boundary information such that the boundary is shifted in the direction for the CM section to be long, and
the output control unit extracts and outputs, when the characteristics output instruction is received by the first reception unit, the characteristic section included in a section indicated as a program section according to the corrected boundary information.

5. The AV content processing device according to claim 1 further comprising a detection unit for calculating a parameter indicating characteristics of one of a sound and an image in the AV content and detecting a section for which the parameter satisfies a predetermined condition as a characteristic section, wherein
the reception unit is operable to receive from the user a characteristics output instruction for extracting and outputting the characteristic section in the program section,
the boundary correction unit corrects, when the characteristics output instruction is received by the first reception unit, the content of the boundary information such that the boundary is shifted in the direction for the CM section to be short, and
the output control unit extracts and outputs, when the characteristics output instruction is received by the first reception unit, the characteristic section included in a section indicated as a program section according to the corrected boundary information.

6. The AV content processing device according to claim 1, wherein
the acquisition unit further acquires CM number information indicating a number of CMs in the CM section and length information indicating a length of the CM section, and
the boundary correction unit selects an amount of shift performed for a boundary indicating a start point and boundary indicating an end point of the CM section, based on the CM number information and length information for the CM section.

7. The AV content processing device according to claim 1, wherein the boundary correction unit selects an amount of shift performed for a boundary indicating a start point and boundary indicating an end point of the CM section, based on a length of a program section immediately before the CM section.

8. The AV content processing device according to claim 1, wherein the boundary correction unit selects an amount of shift performed for a boundary indicating a start point and boundary indicating an end point of the CM section, based on a ratio of a length from a start of the AV content to the CM section to a length of the entire AV content.

9. The AV content processing device according to claim 1, wherein the boundary correction unit corrects, when a predetermined condition is satisfied for the CM section, the boundary information such that a boundary indicating a start point and boundary indicating an end point of the CM section are erased.

10. The AV content processing device according to claim 1 further comprising a program information acquisition unit for acquiring program information which is information concerning a program included in the AV content, wherein
the boundary correction unit changes an amount of shift performed for the boundary based on the acquired program information.

11. An AV content processing method for outputting at least a portion of an AV content including a program section and a CM section, comprising:
an acquisition step of acquiring boundary information indicative of a boundary between the program section and the CM section;
a first reception step of receiving from a user an instruction for extracting and outputting a predetermined section in the AV content;
a boundary correction step of selecting, in accordance with a type of the instruction received by the first reception step, whether the boundary is shifted in a direction for the CM section to be short or long, and correcting a content of the boundary information such that the boundary is shifted in the selected direction; and
an output control step of determining, when the instruction is received by the first reception step, the boundary between the program section and the CM section in accordance with the corrected boundary information, and extracting and outputting a section indicated by the instruction.

12. An AV content processing program executed by a computer of an AV content processing device for outputting at least a portion of an AV content including a program section and a CM section, causing the computer to execute:
an acquisition step of acquiring boundary information indicative of a boundary between the program section and the CM section;
a first reception step of receiving from a user an instruction for extracting and outputting a predetermined section in the AV content;
a boundary correction step of selecting, in accordance with a type of the instruction received by the first reception step, whether the boundary is shifted in a direction for the CM section to be short or long, and correcting a content of the boundary information such that the boundary is shifted in the selected direction; and
an output control step of determining, when the instruction is received by the first reception step, the boundary between the program section and the CM section in accordance with the corrected boundary information, and extracting and outputting a section indicated by the instruction.

13. An integrated circuit used in an AV content processing device for outputting at least a portion of an AV content including a program section and a CM section, comprising:
an acquisition section for acquiring boundary information indicative of a boundary between the program section and the CM section; and
a boundary correction section for a user to input an instruction for extracting and outputting a predetermined section in the AV content, for selecting, in accordance with a type of the instruction, whether the boundary is shifted in a direction for the CM section to be short or long, and correcting a content of the boundary information such that the boundary is shifted in the selected direction.
